(19) United States
(12) Patent Application Publication
(10) Pub. No.: US 2008/0136920 A1
(43) Pub. Date: Jun. 12, 2008

(54) Image Module

(75) Inventors: Mario Loeffler, Dresden (DE); Werner Schneider, Dresden (DE); Gregor Woldt, Dresden (DE); Stephen Karl, Grossdittmannsdorf (DE); Andreas Fischer, Berga (DE)

Correspondence Address: HESLIN ROTHENBERG FARLEY & MESITI PC, 5 COLUMBIA CIRCLE, ALBANY, NY, 12203, US

(73) Assignees: MICROELECTRONIC PACKAGING DRESDEN GMBH, Dresden (DE); WAHL OPTOPARTS GMBH, Triptis (DE)

(21) Appl. No.: 11/572,844

(22) PCT Filed: Jul. 28, 2005
(86) PCT No.: PCT/DE05/01339

§ 371 Date: Apr. 17, 2007

(30) Foreign Application Priority Data
Jul. 28, 2004 (DE) 20 2004 011 854.8

(51) Int. Cl. H04N 5/225; H04N 9/04

(52) U.S. Cl. 348/207.99

(57) ABSTRACT

The invention relates to an image module comprised of the following principal elements: a module board with an image sensor that is mounted thereon or on the rear side thereof by means of flip-chip technology. The aim of the invention is to create an image module in which a simple, precise and rapid mounting of the functional assemblies with the precise allocation of the distance between the surface of the image sensor and the lens system is made possible. To this end, the invention provides that three interspaced spacer elements (9) are placed between the module board (2) and the covering element (7). These spacer elements define the distance between the image sensor (3) on the module board (2) by defining a predetermined air gap (11).

The invention relates to an image module, comprising the principal elements: a module board with an image sensor, which is mounted thereon or on the rear side thereof by means of flip-chip technology, as well as optionally other functional and contact elements on the front and/or rear side of the module board, as well as a covering element for covering the module board with a lens system, which may be arranged over the active area of the image sensor of the image sensor chip and is mounted on the module board by means of chip-on-board [COB] technology or on the rear side of the module board by means of flip-chip technology.

Such image modules are used in different sizes for a number of different imaging purposes, for example, in video devices or any imaging systems. Such image modules contain in essence the module board, on which an image sensor (imaging element) of any model is fastened by chip bonding, e.g., cementing. The image sensor has an active area for converting the images that are imaged in this area by means of the lens system into electric signals. In order to transmit and process these electric signals the module board exhibits other functional elements, such as switching circuits and surface mount (SMD) components, which are connected together, for example, by means of wire bridges or other suitable connecting elements and are connected electrically to the module board. Finally, contact elements are also fastened to the module board. The image module may be mounted, for example, with said contact elements on printed circuit boards.

In order to reproduce an image on the active area of the image sensor the covering element exhibits the aforementioned lens system, comprising at least one lens. However, there are as a rule a plurality of lenses, which are mounted at a fixed predetermined distance from each other and form the lens system. The optical axes of said lenses must be exactly perpendicular to the active area of the image sensor. In addition, the lenses or rather the lens system, comprising a plurality of lenses, or rather the optical plane of said lens system is located at an exactly predetermined distance over the active area of the image sensor. Moreover, it must be guaranteed that the distance from the lenses to the module board cannot change during usage of the image module.

During production of such image modules the adjustment of the lenses or rather the lens system over the image sensor and in particular the correct adjustment of the distance from the image sensor, thus the focusing, is especially complicated and time consuming. For example, the lenses may be housed in a receptacle in the covering element that is adjustable with respect to the image sensor by rotating or sliding.

However, such designs are not suitable for inexpensive focusing, especially since a precise and constant exact adjustment of the focus is difficult to realize.

Therefore, the object of the invention is to create an image module, which does not exhibit the described drawbacks and makes possible in particular a simple, precise and rapid mounting of the functional assemblies with the precise allocation of the distance between the surface of the image sensor and the lens system.

The problem, on which the invention is based, is solved by the characterizing features of claim 1. Other designs of the invention are disclosed in the related dependent claims.

The invention is explained in detail below with reference to one embodiment.

In the related drawings:

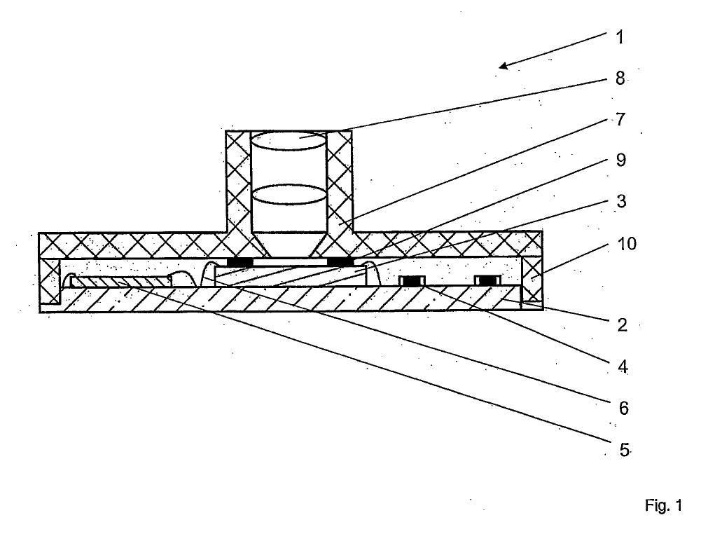

FIG. 1 is a sectional view of an image module with an image sensor, which is mounted on a module board by means of COB technology, with spacer elements, which are disposed on the image sensor, and a related covering element with a lens system;

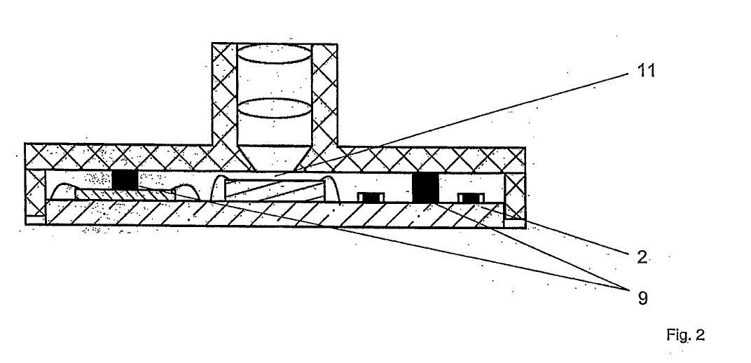

FIG. 2 is a sectional view of an image module with an image sensor, which is mounted by means of COB technology, with spacer elements on the module board and/or other components, like ASIC components, and a related covering element with a lens system;

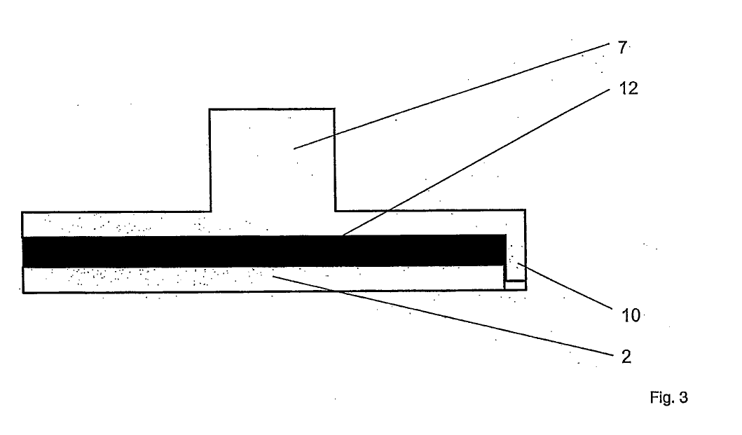

FIG. 3 is a side view of a final assembly of the image module, according to FIG. 1 or FIG. 2;

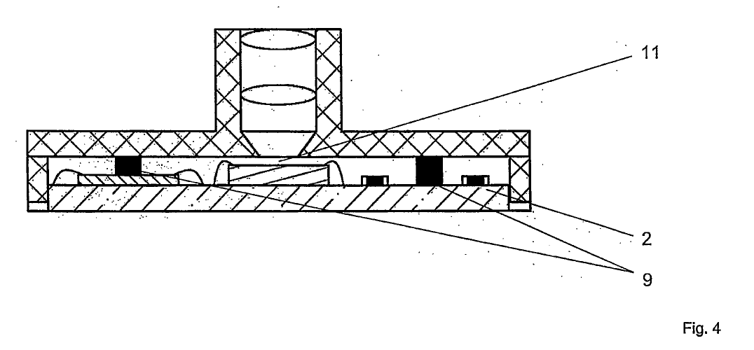

FIG. 4 is a sectional view of an image module with an image sensor, which is mounted by means of flip-chip technology, with spacer elements, which are mounted on the module board and/or other components, like ASIC components, and

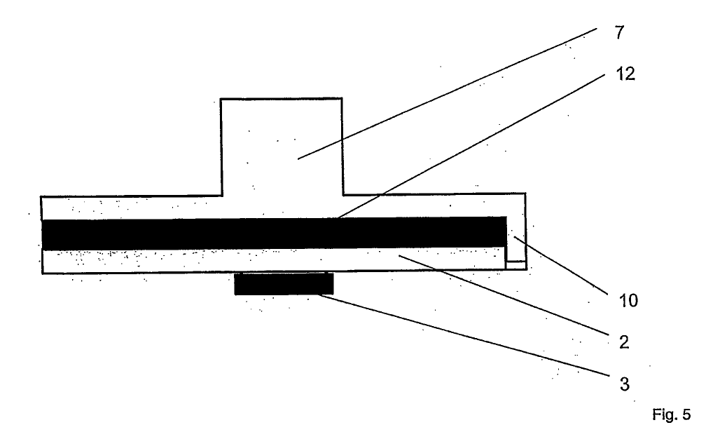

FIG. 5 is a side view of a final assembly of the image module, according to FIG. 4.

FIG. 1 shows an image module 1, comprising the principal elements: module board 2 (base plate/substrate) with an image sensor 3 (imaging element) that is mounted thereon or by means of COB technology. Other functional and contact elements that are mounted on the module board 2 are SMD components 4 and ASIC components 5, which make an electrical contact with the module board by way of wire bridges 6.

A covering element 7 is permanently connected to the module board 2. Said covering element has a lens system 8 that is located at a precisely defined distance over the active area of the image sensor 3.

In order to guarantee a simple mounting of the covering element 7 on the module board 2 and simultaneously ensure that the defined distance between the image sensor 3 and the lens system 8 is maintained in a repeatable manner, spacer elements 9 are placed between the module board 2 and the covering element 7. Said spacer elements define the air gap 11 between the image sensor 3 and the lens system 8.

Furthermore, adjustment elements 10 are provided in the form of pins for the X-Y positioning of the covering element 7. Said adjustment elements are permanently connected to the covering element 7 and extend into the holes in the module board 2.

According to FIG. 1, the spacer elements 9 are positioned on the image sensor 3, thus achieving maximum accuracy in defining the distance between the lens system 8 and the image sensor 3.

FIG. 2 shows a variant, where the distance between the image sensor 3 and the lens system 8 is defined by spacer elements 9 on the module board 2. In this respect the length of the spacer elements 9 is defined by the predetermined distance between the surface of the image sensor 3 and the lens system 8 plus the thickness of the image sensor 3 and plus the thickness of the adhesive layer between the image sensor 3 and the module board 2. This variant is especially necessary when the image sensor 3 does not have enough area for the spacer elements 9.

In addition, the spacer elements 9 can also be disposed on other mounted components on the module board 2.

The covering element 7 simultaneously seals the module board 2 at the top (FIG. 3), thus producing a stable connection between the module board 2 and the covering element 7 by means of an epoxy resin 12.

If the covering element 7 is designed as a cap, which envelops the module board 2 on the side, a lateral mechanical and optical delimitation of the optical area of the image sensor 3 is realized at the same time.

FIG. 4 shows a sectional view of an image module 1 with an image sensor 3, which is mounted by means of flip-chip technology, on the underside of the module board 2 as well as other SMD and ASIC components 4, 5 on the module board 2 and spacer elements 9 on the module board 2.

In a variant the edges of the covering element 7 are designed in the shape of plates. In this way the fastening on the module board 2 is realized by means of an adhesive 12, such as epoxy resin or an adhesive foil, that is applied in addition. This variant is especially advantageous if the simultaneous complete mounting of a plurality of image modules 1 is supposed to be carried out so as to form an effective composite structure.

Additional adhesive, which has escaped on the side while mounting the covering element 7 on the module board 2, can be removed in a simple way by means of suitable methods, like cutting or sawing, preferably while detaching the image modules 1 from the effective composite structure.

### LIST OF REFERENCE NUMERALS

1 image module
2 module board
3 image sensor
4 SMD component
5 ASIC component
6 wire bridge
7 covering element
8 lens system
9 spacer element
10 adjustment element
11 air gap
12 adhesive

1. An image module, comprising:
a module board with an image sensor that is mounted thereon or on the rear side thereof by means of flip-chip technology;
a covering element for covering the module board with a lens system, said covering element arranged over an active area of the image sensor and mounted on the module board by means of COB technology or on a rear side of the module board by means of flip-chip technology;
three interspaced spacer elements placed between the module board and the covering element; and
said spacer elements define a distance between the image sensor and the module board by defining a predetermined air gap.

2. The image module, as claimed in claim 1, wherein the spacer elements are a component of the covering element, and further comprising additional adjustment elements for the X-Y positioning of the covering element on the module board.

3. The image module, as claimed in claim 1, wherein the distance between the image sensor and the lens system is defined by the spacer elements between the image sensor and the lens system in the covering element.

4. The image module, as claimed in claim 1, wherein a distance between the image sensor and the lens system is defined by the spacer elements.

5. The image module, as claimed in claim 4, wherein the spacer elements exhibit a length that is defined by a predetermined distance between the surface of the image sensor and the lens system plus the thickness of the image sensor and plus the thickness of the adhesive layer between the image sensor and the module board.

6. The image module, as claimed in claim 1, wherein a distance between the image sensor and the lens system is defined by the spacer elements.

7. The image module, as claimed in claim 1, wherein the adjustment elements are a component of the covering element or a separate component, said adjustment element received by the matching holes in the module board and locked in position therewith.

8. The image module, as claimed in claim 1, wherein the covering element is constructed in such a manner that the corresponding lens system may be accommodated; and the position of the lens system in the X, Y and Z direction relative to the image sensor surface is defined by means of the spacer elements and the adjustment elements.

9. The image module, as claimed in claim 1, wherein the covering element simultaneously seals the module board at the top.

10. The image module, as claimed in claim 10, wherein the covering element comprises a sealing cap; and said cap provides a lateral mechanical and optical delimitation of the optical area of the image module.

11. The image module, as claimed in claim 1, wherein the sealing covering element is configured in the shape of a plate; and the lateral delimitation is realized by means of an adhesive, that is applied in addition, said adhesive comprising at least one of an epoxy resin and another suitable adhesive.

12. The image module, as claimed in claim 2, wherein a distance between the image sensor and the lens system is defined by the spacer elements between the image sensor and the lens system in the covering element.

13. The image module, as claimed in claim 2, wherein a distance between the image sensor and the lens system is defined by the spacer elements.

14. The image module, as claimed in claim 1, wherein a distance between the image sensor and the lens system is defined by the spacer elements.

15. The image module, as claimed in claim 2, wherein the adjustment elements are a component of the covering element or a separate component, said adjustment element received by the matching holes in the module board and locked in position therewith.

16. The image module, as claimed in claim 3, wherein the adjustment elements are a component of the covering element or a separate component, said adjustment element received by the matching holes in the module board and locked in position therewith.

17. The image module, as claimed in claim 4, wherein the adjustment elements are a component of the covering element or a separate component, said adjustment element received by the matching holes in the module board and locked in position therewith.

18. The image module, as claimed in claim 5, wherein the adjustment elements are a component of the covering element or a separate component, said adjustment element received by the matching holes in the module board and locked in position therewith.

19. The image module, as claimed in claim 6, wherein the adjustment elements are a component of the covering element or a separate component, said adjustment element received by the matching holes in the module board and locked in position therewith.

20. The image module, as claimed in claim 2, wherein the covering element is constructed in such a manner that the corresponding lens system may be accommodated; and the position of the lens system in the X, Y and Z direction relative to the image sensor surface is defined by means of the spacer elements and the adjustment elements.
